(19) United States
(12) Patent Application Publication
(10) Pub. No.: US 2007/0220918 A1
(43) Pub. Date: Sep. 27, 2007

(54) Pressure setting method for gas pipeline

(76) Inventors: Paul F. Scharf, North Tonawanda, NY (US); Stefan Hoskin, Valparaiso, IN (US); Will Hardy, Commerce Twp., MI (US); Paul Moscynski, Wyandotte, MI (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/387,708

(22) Filed: Mar. 24, 2006

(51) Int. Cl. F17D 3/00; F25J 3/00

(52) U.S. Cl. 62/656; 137/8

(57) ABSTRACT

A method of setting a set point pressure of a back-up supply to supply gaseous product to the pipeline should pipeline pressure fall below the set point pressure. The pipeline and the back-up supply are part of a gas distribution network also having a production facility for supplying the pipeline with the gaseous product at the target pressure for distribution to customers connected to the pipeline. The set point pressure for the back-up gas supply is continuously calculated by calculating a series of pressure drops for each of the customers being fed by the pipeline and then determining required customer site pressures by adding the minimum contracted supply pressure for each of the customers to their respective pressure drops. The maximum required customer site pressure is utilized as the set point pressure for the back-up supply. Optionally, the target pressure at which the gas is to be produced by the facility is determined on the basis of the set point pressure calculated for the back-up supply and can be accomplished by adding to such set point pressure, an average of average high pipeline pressures and average low pipeline pressures that result from pressure responses in the pipeline due to maximum and minimum customer demands.

### FIELD OF THE INVENTION

The present invention relates to a method of setting a set point pressure of a back-up supply connected to the pipeline of a gas distribution network and optionally, for setting a target pressure to be maintained in the pipeline itself. More particularly, the present invention relates to such a method of setting the set point pressure and the target pressure in which pressures are continually set on the basis of pressure drop within the pipeline and contractual requirements of customers connected to the pipeline.

### BACKGROUND OF THE INVENTION

Gaseous products can be supplied to customers by use of a gas distribution network that incorporates a pipeline to supply the gaseous product to the customers, a production facility connected to the pipeline that is used to generate the gaseous product and a back-up supply that is also connected to the pipeline to feed the pipeline with a back-up source of the gaseous product.

Each production facility can have more than one pipeline when multiple products are produced at the facility. Additionally, within each facility, there may be a series of producing plants. For example, a production facility can incorporate one or more cryogenic air separation plants that feed oxygen and nitrogen products to respective oxygen and nitrogen pipelines. Alternatively, the product can be hydrogen. In such case, the hydrogen can be produced by steam methane reforming of a hydrocarbon containing feed, typically, natural gas that produces synthesis gas. The synthesis gas can be subjected to a water-gas shift reaction to increase its hydrogen content and subsequently, the hydrogen product is separated from the synthesis gas by a pressure swing absorption unit.

The gaseous product is introduced into the pipeline by means of a product compressor located within the production facility. The production facility incorporates automated controls to control production of the gaseous product and the pipeline pressure to maintain the pipeline pressure at a target pressure within the pipeline. The maintenance of pipeline pressure is important because each of the customers being supplied by the pipeline has a minimum contract supply pressure that constitutes a pressure that is guaranteed by the producer at the point the customer is connected to the pipeline.

In order to compensate for extraordinary customer demands or outage of the production facility or one of the production units contained in the production facility, a back-up supply provides a back-up source of the gaseous product to the pipeline should pipeline pressure fall below a set point pressure. In case of atmospheric gas distribution, the back-up source of gas is typically stored as a liquid product. When needed, a vaporizer vaporizes the liquid product and the resultant gas is fed to the pipeline. The back-up supply normally has a valve that is actuated by a pressure controller connected to the pipeline that opens the valve when the pipeline pressure falls below the set point pressure that is normally set at a constant level.

An illustration of an automated control to a gas distribution network can be found in U.S. Pat. No. 6,697,713 in which production of one or more gaseous products by one or more air separation plants is controlled to maintain the pipelines at target pressures. In order to accomplish this, a pipeline controller is provided that functions on the basis of model predictive control. The production rate of the gaseous products, for example oxygen and nitrogen, are used as manipulated variables. The pipeline pressure itself is a controlled variable. The flow rate of the products to be drawn from the customers are feed forward variables. All of these variables are related by empirically based step response models that are cumulatively utilized to forecast changes in pipeline pressure and an optimized set of control actions that are used to change production of the plants to maintain the pipeline pressure within a target range. Instantaneous transients are handled by adding additional gaseous product to the pipeline from back-up supply of the gaseous product should pipeline pressure fall below a predetermined set point pressure and venting gaseous product should pipeline pressure exceed an allowable pipeline pressure.

In a gas distribution network, it is desirable to minimize the production costs. In case of a gas distribution network that distributes atmospheric gases, the production costs relate directly to energy costs of operating each of the air separation plants that are used in the production. In an air separation plant, air is compressed and cooled to at or near its dew point and then is distilled within distillation columns to produce the oxygen and nitrogen gaseous products. The power consumption of the compressor is therefore a central production cost for such a plant. Additionally, product compressors represent an additional cost for the product that is compressed before being fed into the pipeline.

Liquid products, particularly in case of liquid oxygen produced by air separation plants, are value added products that are more expensive than the gaseous products to produce. The setting of set point pressures of the back-up supply at a constant level can result in excessive consumption of liquid products due to the fact that at times, even though the pipeline pressure is at or even below the set point for the back-up supply, gaseous product is still being supplied to customers at contract pressure due to low customer demand. Thus, the supply of back-up gaseous product under such circumstances represents an unnecessary expense.

In heavily automated systems, such as discussed above or even semi-automated systems that require continual operator intervention to control production, the product must be fed to the pipeline at a specific target pressure or range of pressure that must be maintained in order to meet the conceivable customer demands and to maintain the minimum contract supply pressure to the customer. This pressure will be above the set point pressure for the back-up supply. Typically, it is set at a level that will guarantee the minimum gas supply contract pressures are maintained based upon historical customer demand. This pressure can also at times be at an unnecessary high a level when customer demand is low. This results in unnecessary production expenses in operating the gas distribution system.

As will be discussed, the present invention provides a method of setting the set point pressure at which back-up gaseous product is supplied on an ongoing basis to help prevent excessive consumption of the back-up gaseous product and that optionally can be applied to setting the target pressure at which pipeline pressure is to be maintained.

### SUMMARY OF THE INVENTION

The present invention relates to a method of setting a set point pressure of a back-up supply to supply a gaseous product to a pipeline should pipeline pressure fall below the set point pressure. The pipeline distributes the gaseous product to customers connected to the pipeline.

In accordance with the invention, continually, upon elapse of calculation time intervals, required customer site pressures are computed. This computation is performed by measuring flow rates of the gaseous product to each of the customers. A series of pressure drops is calculated for each of the customers along the pipeline and between the production facility and each of the customers. Each of the pressure drops is a function of flow rate of the gaseous product to each of the customers and pressure and temperature within the pipeline at the customer site. Preferably, the temperature and the pressure are measured at each of the customer sites and used in calculating each of the pressure drops.

Added to each of the series of pressure drops is a minimum contracted supply pressure to determine the required customer site pressure. At the conclusion of the computation of the required customer site pressures, the set point pressure is set within the back-up source of gaseous product to be equal to a site pressure that has the greatest magnitude.

The temperature and the pressure can be measured at each of the customer sites and then used in calculating each of the pressure drops. Each of the pressure drops is calculated on the basis of mass flow of the gaseous products to each of the customers.

The pipeline and the back-up supply are part of a gas distribution network also having a production facility for supplying the pipeline with the gaseous product at a target pressure. Variation in demand for the gaseous product by the customers produces a cyclical variation of high and low pressures within the pipeline. The target pressure can be set, upon setting the set point pressure of the back-up supply, equal to a sum of the set point pressure and a difference between average high and low pressures within the pipeline divided by two.

The production facility can be one or more cryogenic air separation plants and the gaseous product can be an atmospheric gas produced by the cryogenic air separation plant. The atmospheric gas can be either oxygen or nitrogen.

As can be appreciated, at any given time, the set point pressure at which back-up gaseous product will be delivered will vary with customer demand so that pipeline pressure will be maintained at a level that is sufficient to meet contractual gas supply requirements should pipeline pressure fall due to a transient. The set point pressure will therefore, not be at what can amount to an artificially high, constant pressure, that will result, at times, unnecessary back-up gaseous product being supplied to the pipeline. The target pressure of the pipeline can also be made to vary with customer demand. Since a constant made up of average high and low pressures is added to the set point pressure to arrive at the pipeline target pressure, the target pressure will be above the set point pressure of the back-up supply, yet vary, so that excessively high target pressures, beyond those needed at any one time, are not set for the production facility.

### BRIEF DESCRIPTION OF THE DRAWINGS

While the specification concludes with claims distinctly pointing out the subject matter that Applicants regard as their invention, it is believed that the invention will be better understood when taken in connection with the accompanying drawings in which:

FIG. 1 is a schematic view of a gas distribution network incorporating a method in accordance with the present invention;

FIG. 2 is a logic flow diagram of a computer program used in calculating target and set point pressure;

FIG. 3 is a graphical depiction of a typical customer pipeline demand flow pattern; and

FIG. 4 is a graphical depiction of a resultant pipeline pressure pattern produced by the customer pipeline demand flow illustrated in FIG. 2.

### DETAILED DESCRIPTION

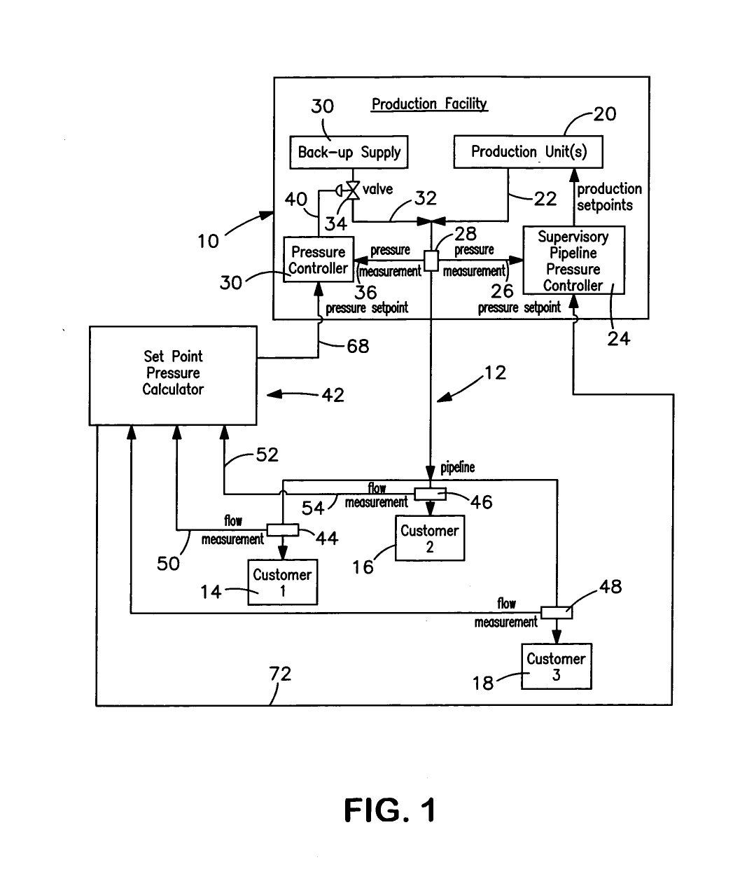

With reference to FIG. 1, a gas distribution network 1 is illustrated that has a production facility 10 that produces and feeds a gaseous product to a pipeline 12 for use by customers 14, 16 and 18.

Production facility 10 has one or more production units 20, which for purposes of illustration can be one or more cryogenic air separation plants. It is to be noted, however, that the present invention would have applicability to other types of pipelines, for example, hydrogen pipelines.

In a cryogenic air separation plant, air is compressed and then cooled to at or near its dew point and thereafter, introduced into a double column system having higher and lower pressure columns operatively associated in a heat transfer relationship to successively refine the air to produce gaseous oxygen and nitrogen products and also potentially liquid oxygen and liquid nitrogen products. Again, for purposes of illustration, it will be assumed that production units 20 supply a gaseous oxygen stream 22 to pipeline 12. If, for example, there were more pipelines or pipelines carrying different products, the invention described below with respect to an illustrated embodiment would be applied to each of the pipelines.

Although not illustrated, the production units 20 are typically controlled by automated control systems such as supervisory control systems utilizing supervisory control and data acquisition programs. There are a variety of control schemes that are employed in such control systems that are well known in the art. Production requests that are fed to such supervisory control systems in turn control production of the air separation plants. The production requests are generated by a controller 24 that is responsive to a pressure signal 26 referable to the pressure in pipeline 12 that is sensed by a pressure transducer 28. Controller 26 sets such production requests so as to maintain pipeline pressure in pipeline 12 at a target pressure. Neither controller 26 nor the supervisory control system utilized in controlling the air separation plants form part of the present invention. However, it should be mentioned that controller 26 and the supervisory control system of the air separation plants could be the heavily automated network that is set forth in U.S. Pat. No. 6,697,713, described above. At the other extreme, controller 24 could employ individual operator intervention to maintain pipeline pressure at the target pressure by simply reading an indicator responsive to the pressure signal 26 and indicative of pressure and manually setting production of the air separation plants to maintain a pre-specified target pressure.

Production facility 10 also has a back-up supply 30. Back-up supply 30 consists of a liquid tank to hold a supply of the pipeline product in liquid form, for example, liquid oxygen and a vaporizer to vaporize the liquid into an oxygen back-up gas stream 32 as a back-up product gas to also feed pipeline 12. Pressure transducer 28 also generates a signal 36 that is referable to pipeline pressure. A pressure controller 38, that can be a proportional integral and differential controller, is responsive to signal 36 and by connection 40 opens valve 34 when the pressure within pipeline 12 falls below a set point pressure for pressure controller 38.

Again, the guarantee of a minimum pressure to customers 14, 16 and 18 is contractual. In case of excessive customer demand or in case of a partial outage of production units 20, pipeline pressure within pipeline 12 can fall below the contractual limitations. In such case, valve 34 opens to supply oxygen back-up gas stream 32 to pipeline 12. Since the gaseous oxygen contained in oxygen back-up gas stream 32 is a value added liquid oxygen product produced by production units 20, the use of back-up supply 30 adds expense to the operation. Typically, in the prior art, this pressure is set at a constant level that is determined to meet customer contract supply pressures based upon historical customer demand and operational experience. This constant pressure may not be required to meet actual customer demand at any given moment. As a result, unnecessary back-up gas can be supplied to pipeline 12.

Typically, in the prior art, the target pressure to be maintained within the pipeline 12 is that pressure that will maintain the contract pressure guaranteed to each of the customers. Should customer demand decrease, the production of production unit(s) 20 will also decrease to maintain the target pressure at a constant level. However, if the target pressure is set at a constant level, the pressure at times will be greater than that required to meet current customer demand. Consequently, at certain times of customer demand either too much of the gaseous product is being produced and/or there is excessive product compression. The present invention contemplates embodiments thereof in which such target pressure is set at a constant level in a manner that is exactly the same as in the prior art. However, as will be discussed, such target pressure can advantageously be made to fluctuate with a variable set point pressure for back-up supply 30.

In order to solve the problems outlined above, a variable supply set point pressure determination is continually computed by software indicated as set point pressure calculator 42. Such software can reside on the same digital device as present in controller 24 or it could be on a personal computer having outputs to both controller 24 and pressure controller 38 for valve 34. The calculation of set point pressure involves the determination of flow rates of the gaseous products being consumed by each of customers 14, 16 and 18. To such end, flow transducers 44, 46 and 48 are provided that produce input signals 50, 52 and 54 that are referable to the flows. Input signals 50, 52 and 54 are fed as inputs to the set point pressure calculator 42 that can function solely on the basis of data relating to flow alone. Preferably, though, each of the flow transducers 44, 46 and 48 can be pressure sensors located on opposite sides of an orifice plate with temperature sensors. Such pressure and temperature data can also be fed to set point pressure calculator 42. Alternatively, temperature and pressure could be separately monitored from the measurements of customer flows or in regions with stable climates, the pressure and temperature could simply be estimated and not actually measured.

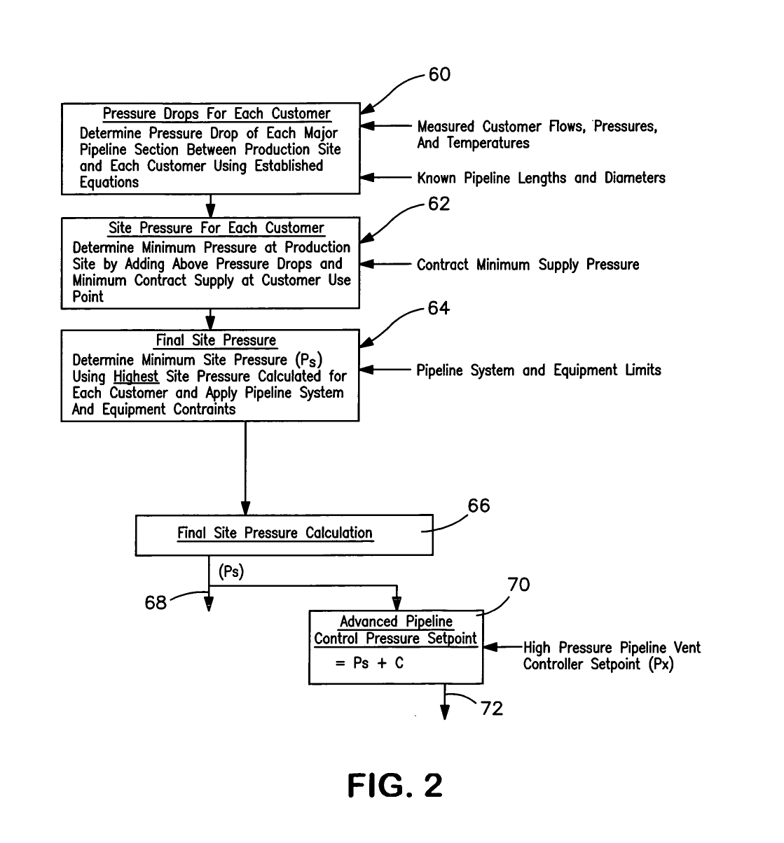

With reference to FIG. 2, a logic flow diagram contained within variable supply set point pressure calculator 42 is shown. The program continually executes upon elapse of a calculation time interval which can be between one and five minutes.

Upon execution of the program, required customer site pressures are computed. As a first step in the computation, as indicated in execution block 60 a series of pressure drops for each of the customers 14, 16 and 18 are determined between the production facility 10 and each of the customers 14, 16 and 18. The data input is the measured customer flows from transducers 44, 46 and 48 via respective input signals 50, 52 and 54. As indicated above, signals 50, 52 and 54 can be referable to flow and can also have data representing local pressure and temperature at each of the customer sites. Additionally, the pipeline lengths and diameters are also an input and can be stored as a data file accessed by the program.

The pressure drop for each of the customers 14, 16 and 18 is then calculated with the following equation: Pressure Drop=A×FLOW^{B}×(TEMPERATURE/PRESSURE)+C. In the equation, the terms, “A”; “B”; and “C” are dependent upon the “FLOW”, pipeline length and diameter, as determined for each pipeline section between a particular customer and the production site. Where pipe diameters change, the pressure drop for each pipeline section is computed and the pressure drop is the sum of the individual pressure drops for each of the sections. These constants are determined in a manner well known in the art by testing the pipeline itself or through simulation that is confirmed through testing. The “FLOW” is a mass flow. Volumetric flow could also be utilized. In such case and as well known in the art, the equation would be related to pressure drop and density of the product gas, also a function of temperature and pressure.

The result of the computations is then utilized in the computation as set forth in execution block 62. In execution block 62 the minimum contract supply pressure for each of the customers 14, 16 and 18 is added to the respective pressure drops computed in execution block 60. The sum is the required customer site pressures. Contract minimum supply pressure is an input of this section of the program and can simply be data within a stored data file. The required customer site pressures are then utilized in further calculations set forth in execution block 64. The required or final customer site pressure that has the greatest magnitude or a pressure that represent the pipeline system and equipment limits, whichever is less, is selected at execution block 66 and is indicated as pressure “Ps”. The limiting pressure is also a data record accessed in execution block 66 and represents known working pipeline pressure constraints as measured at the production site. This particular pressure forms the set point pressure for pressure controller 38 that is sent as an output from set point pressure calculator 42 to pressure controller 38 by way of signal 68.

It is to be noted that the pipeline system and equipment limits are, for example, the maximum rated pipe pressure, valve pressure ratings and other equipment pressure limitations. Although it is possible to calculate and use the set point pressure without such constraint, the result at times might be to vent product gas by pipeline pressure relief valves resulting in an undesirable loss of product gas.

Additionally, a further calculation can be made, as indicated in execution block 70, to determine the target pressure for controller 24 that is a simple addition of a constant to the set point pressure. The resulting target pressure can be supplied to controller 24 by way of signal 72.

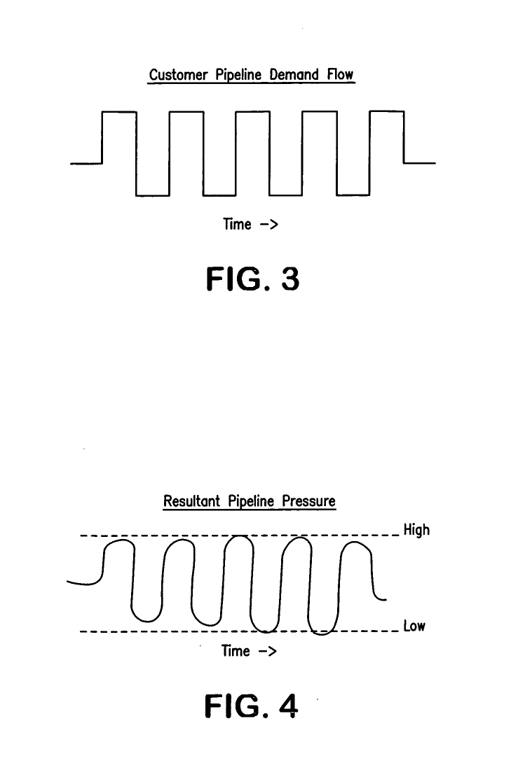

With reference to FIGS. 3 and 4, this constant can be selected by collecting historical customer demand flow requirements shown in FIG. 4. These customer demand flows, that vary between a maximum and minimum, produce a resultant varying pipeline pressure response shown in FIG. 5. The pressure response varies between maximum and minimum pressures. The constant in such case is simply the difference between the average high pressures and low pressures within pipeline 12, that are measured by pressure transducer 28, divided by two or in other words an average of the average high and low pressure responses within pipeline 12. In FIG. 5, the average high pressures and the average low pressures are indicated by the dashed lines. Setting the target pressure in such manner will minimize excursions where back-up product gas will have to be used, while at the same time, allow the target pressure to vary to prevent unnecessary over-production of the gaseous product.

While the present invention has been described with reference to preferred embodiments, as will occur to those skilled in the art, numerous changes, additions and omissions can be made without departing from the spirit and the scope of the present invention.

We claim:

1. A method of setting a set point pressure of a back-up supply to supply a gaseous product to a pipeline should pipeline pressure fall below the set point pressure, the pipeline distributing the gaseous product to customers connected to the pipeline, said method comprising:
continually, upon an elapse of calculation time intervals, computing required customer site pressures by:
measuring flow rates of the gaseous product to each of the customers;
calculating a series of pressure drops for each of the customers along the at least one pipeline and between the production facility and each of the customers, each of the pressure drops being a function of the flow rate, the pressure and the temperature within the pipeline at a customer site; and
adding to each of the series of the pressure drops a minimum contracted supply pressure to determine the required customer site pressures; and
at the conclusion of the computation of the required customer site pressures, setting the set point pressure within the back-up source of gaseous product equal to a required customer site pressure of the required customer site pressures that has the greatest magnitude.

2. The method of claim 1, further comprising:
the pipeline and the back-up supply being part of a gas distribution network also having a production facility for supplying the pipeline with the gaseous product at a target pressure and variation in demand for the gaseous product by the customers produces a cyclical variation of high and low pressures within the pipeline; and
setting the target pressure, upon setting the set point pressure of the back-up supply, equal to a sum of said set point pressure and a difference between average high and low pressures divided by two.

3. The method of claim 1, wherein the temperature and the pressure are measured at each of the customer sites and used in calculating each of the pressure drops.

4. The method of claim 1, wherein each of the pressure drops is calculated on the basis of mass flow of the gaseous products to each of the customers.

5. The method of claim 2, wherein the production facility is at least one cryogenic air separation plant and the gaseous product is an atmospheric gas produced by the cryogenic air separation plant.

6. The method of claim 3, wherein each of the pressure drops is calculated on the basis of mass flow of the gaseous products to each of the customers.

7. The method of claim 6, further comprising:
the pipeline and the back-up supply being part of a gas distribution network also having a production facility for supplying the pipeline with the gaseous product at a target pressure and variation in demand for the gaseous product by the customers produces a cyclical variation of high and low pressures within the pipeline; and
setting the target pressure, upon setting the set point pressure of the back-up supply, equal to a sum of said set point pressure and an average of the high and low pressures.

8. The method of claim 7, wherein the production facility is at least one cryogenic air separation plant and the gaseous product is an atmospheric gas produced by the cryogenic air separation plant.
